(19) United States
(12) Patent Application Publication
(10) Pub. No.: US 2017/0110857 A1
(43) Pub. Date: Apr. 20, 2017

(54) Apparatus for Collecting and Filtering Arc By-Products

(71) Applicant: G.M.G. ENGINEERING SERVICES LTD., Mississauga (CA)

(72) Inventor: Mario Gasparetto, Mississauga (CA)

(21) Appl. No.: 14/952,985

(22) Filed: Nov. 26, 2015

(30) Foreign Application Priority Data
Oct. 14, 2015 (CA) 2909064

(51) Int. Cl. H02B 1/30; H02B 1/56; B01D 39/20; B01D 46/00; B01D 53/04

(52) U.S. Cl. CPC H02B 1/306; B01D 46/0005; B01D 46/0024; B01D 46/0036; B01D 46/0038; B01D 53/04; B01D 39/2003; B01D 39/2027; B01D 39/2055; H02B 1/565; B01D 2253/102; B01D 2257/502; B01D 2257/304; B01D 2257/7025; B01D 2267/40; B01D 2279/35; B01D 2279/45

(57) ABSTRACT

An apparatus for collecting and filtering contaminated air expelled from a switchgear assembly following an arc fault. The apparatus includes a plenum extending from an inlet opening to an outlet opening, the inlet opening configured for sealing engagement with the switchgear assembly, so as to receive the contaminated air expelled thereby. At least one filter is arranged within the plenum for filtering arc by-products from the contaminated air. The apparatus is configured to direct the contaminated air through the at least one filter to produce filtered air, and to exhaust the filtered air from the outlet opening.

### RELATED APPLICATIONS

This application claims the benefit of priority under 35 U.S.C. 119(a) to (d) to Canadian Patent Application Serial No. 2,909,064, filed Oct. 14, 2015, which is hereby incorporated by reference.

### FIELD OF THE INVENTION

This invention relates to devices that collect and filter arc by-products expelled from a switchgear following an arc fault.

### BACKGROUND OF THE INVENTION

Medium voltage switchgear enclosures are commonly employed in the electrical distribution industry to house electrical switchgear components such as circuit breakers, fuses and switching elements. For a variety of reasons, unexpected arc faults may occur inside switchgear enclosures. The potential hazards of arc faults are well known in the industry. Specifically, during an arc fault, a significant amount of electrical energy is discharged in the form of an electrical arc between conductors. The sudden discharge leads to a dramatic increase in both the temperature and the pressure inside the enclosure. Additionally, arc fault may also cause metal conductors to vaporize, thereby producing toxic fumes and/or molten debris. The mixture of highly pressurized hot gas and toxic fumes may potentially damage equipment as well as cause bodily harm to personnel within the immediate surrounding.

Accordingly, arc-resistant switchgear enclosures are required to be equipped to withstand the pressure and temperature of the gases produced by an arc fault. The safety requirements for arc resistant switchgear in North America are set out by the ANSI/IEEE C.37.20.7-2007 Standard. In dealing with the by-products of an arc fault, prior solutions have proposed various measures to direct the by-products away from personnel and nearby equipment.

One such arrangement is disclosed in U.S. Pat. No. 8,101,881 to Miller et al., issued on Jan. 24, 2012, which discloses an exhaust system for exhausting gases and molten debris caused by an electric arc within a switchgear. The exhaust system includes a switchgear having lower and upper compartments and an exhaust unit externally mounted to the switchgear. A wall panel of the switchgear includes blow out panels coinciding with openings in the lower compartment and corresponding ventilation flaps in a top surface of the exhaust unit to exhaust gas from the lower compartment out the blow out panels in a vertical direction, exiting through the flaps. The upper compartment includes ventilation flaps for exhausting gas in a vertical direction directly through the flaps and optionally through side-mounted blow out panels that communicate with the vertical vent path to the flaps in the top of the exhaust unit. A bus compartment in the exhaust unit includes a vent path to flaps in the top of the exhaust unit for exhausting gas produced by bus arcing.

Another arrangement is disclosed in U.S. Pat. No. 7,952,857 to Motley et al, issued on May 31, 2011, which discloses an arc-resistant enclosure for electrical switchgear which includes solid front and back walls, a pair of solid side walls joined to the front and back walls, a ventilated roof joined to the side walls and the front and back walls, and a ventilated base joined to the side walls and the front and back walls. Internal partitions divide the space enclosed by the front, back, side, top and bottom walls into multiple compartments for housing different types of components. The ventilated base forms air-intake ports for admitting ambient air into a plurality of the compartments, and the ventilated roof forms air-exhaust ports for allowing air to be exhausted from the compartments. As air inside the enclosure is heated by the switchgear, the hot air rises through the switchgear compartments and is exhausted through the top air-exhaust ports, and replacement ambient air is drawn into the bottoms of the compartments through the air-intake ports. The air-intake ports are equipped with respective closure panels that automatically close in response to the sudden pressure increase that occurs inside the enclosure when an arcing fault occurs, such that the arc by-products are only discharged through the top air-exhaust ports.

The prior art solutions, such as the ones described above, do not adequately address the harmful effects that the exhausted arc by-products may have on the environment they are released into. The smoke and toxic gas that is released may pose serious health and environmental concerns, such that under some circumstances, the release of the arc by-products into the outdoor environment may be strictly prohibited. An indoor release of the arc by-products may furthermore necessitate an immediate evacuation of the facility, and cause extensive contamination requiring a costly clean-up.

### SUMMARY OF THE INVENTION

To at least partially overcome some of the disadvantages of previously known devices, the present invention provides an apparatus that collects and filters the contaminated air expelled from an arc-resistant switchgear assembly. The apparatus comprises a filtering plenum that is configured to receive the contaminated air from the switchgear assembly; to pass the contaminated air through at least one filter to produce filtered air; and then to exhaust the filtered air. The at least one filter may include, for example, a set of aluminum filters for removing particles from the contaminated air, a micro-glass filter to remove smoke particles, and a charcoal filter to remove toxic gas. The inventor has appreciated that the filtering apparatus is able to significantly reduce the hazards and costs associated with the occurrence of an arc fault in a switchgear assembly. For example, because the air exhausted from the apparatus can be made free of toxic gas and smoke, it is possible to exhaust the air outdoors, even in residential areas with strict air quality requirements. Furthermore, if the filtered air is exhausted indoors, the facility and nearby equipment does not become contaminated, and thus it is possible to avoid a costly cleanup and any associated suspension of operations. In an exemplary embodiment of the invention, the exhausted filtered air was found to contain smoke particles having a maximum size of 0.3 microns, and only 8 ppm of toxic gas.

In some embodiments of the invention, the filtering apparatus is configured to attach directly to an existing arc-resistant switchgear assembly. An existing arc-resistant switchgear assembly may comprise one or more switchgear devices provided with arc-resistant enclosures, with associated vents or plenums that direct the arc by-products away from personnel and nearby equipment, and release the by-products from exhaust ports located inside or outside the facility. In suitable cases, the filtering apparatus can be configured to engage in a fluid tight manner with these existing exhaust ports, so that all of the arc by-products expelled thereby are received by the filtering apparatus, instead of being directly exhausted into the room or outdoor environment. The filtering apparatus then filters the contaminated air, and exhausts filtered air.

In some existing arc-resistant switchgear assemblies, the size of the existing plenum for redirecting the arc by-products may not be large enough to sufficiently cool and depressurize the arc by-products before they enter the filtering plenum. This could damage the filtering plenum, or prevent it from functioning effectively and safely. In such cases, an additional collecting plenum may be used, together with the filtering plenum, to modify the existing arc-resistant switchgear assembly. The collecting plenum is configured to have a sufficient size and strength to safely receive the arc by-products expelled from the switchgear assembly, so that the contaminated air can be sufficiently cooled and depressurized before entering the filtering plenum. A blast arrestor can be placed between the collecting plenum and the filtering plenum, to reduce the flow rate of the contaminated air entering the filtering plenum, and to ensure that the contaminated air is sufficiently cooled and depressurized before passing through the filtering plenum. The blast arrestor may, for example, take the form of one or more perforated metal sheet screens. In some embodiments of the invention, the collecting plenum and the filtering plenum may be formed as one integrated structure, with the blast arrestor delineating the boundary between the two functionally distinct areas.

In other embodiments, the invention provides an arc-resistant switchgear assembly, including at least one switchgear device, a collecting plenum, and a filtering plenum. The switchgear device is provided with an arc-proof enclosure, which directs the arc by-products into the collecting plenum. As in the embodiments described above, the contaminated air is then passed through the filtering plenum to produce filtered air. Such a switchgear assembly may be used for new installations, or to replace existing equipment that is aging and/or insufficiently arc resistant.

Accordingly, in one aspect the present invention resides in an apparatus for collecting and filtering contaminated air expelled from a switchgear assembly following an arc fault, comprising: a plenum extending from an inlet opening to an outlet opening, the inlet opening configured for sealing engagement with the switchgear assembly, so as to receive the contaminated air expelled thereby; and at least one filter arranged within the plenum for filtering arc by-products from the contaminated air; wherein the apparatus is configured to direct the contaminated air through the at least one filter to produce filtered air, and to exhaust the filtered air from the outlet opening.

In another aspect, the present invention resides in a switchgear assembly comprising: at least one switchgear device; a collecting plenum configured to receive arc by-products expelled from the at least one switchgear device during an arc fault; and a filtering plenum configured to filter contaminated air exhausted from the collecting plenum; wherein the filtering plenum extends from an inlet opening to an outlet opening, the inlet opening in sealing engagement with an exhaust port of the arc by-product collecting plenum, so as to receive the contaminated air exhausted therefrom; and wherein the filtering plenum comprises at least one filter for filtering the arc by-products from the contaminated air.

In some embodiments, the apparatus further comprises a blast arrestor arranged upstream of the at least one filter and configured to reduce a flow rate of the contaminated air. The blast arrestor may comprise a perforated metal sheet, and may be arranged at the inlet opening. In some embodiments, the perforated metal sheet has perforations sized to prevent burning particles expelled from the switchgear assembly from passing therethrough, and/or to reduce the flow rate of the contaminated air sufficiently to allow the contaminated air to cool to a suitable temperature for the at least one filter. The perforations may be sized to reduce the flow rate of the contaminated air sufficiently to allow the contaminated air to cool to less than 120 degrees Celsius, or to less than 60 degrees Celsius.

The apparatus may further include a fan configured to draw the contaminated air through the at least one filter, and to exhaust the filtered air from the outlet opening. An arc detecting device may be used to activate the fan upon detecting the arc fault, for example by detecting smoke and/or light produced by the arc fault.

In some embodiments, a shutter is arranged within the plenum upstream of the at least one filter, wherein the shutter is movable between an open position and a restricted position to adjust the flow rate of the contaminated air.

The arc by-products may include smoke and toxic gas, and the at least one filter may be configured to remove the smoke and toxic gas from the contaminated air. The at least one filter may include at least one micro-glass filter, at least one aluminum filter and at least one charcoal filter. The at least one filter may be configured to remove all particles larger than 0.3 μm from the contaminated air, and/or to remove carbon monoxide from the contaminated air to a concentration of less than 10 ppm.

The apparatus may further comprise at least one spark arrestor arranged within the plenum. The spark arrestor may, for example, be formed as a metallic screen.

In some embodiments, the inlet opening is a first inlet opening configured for sealing engagement with a first exhaust port of the switchgear assembly; wherein the plenum has a second inlet opening configured for sealing engagement with a second exhaust port of the switchgear assembly; and wherein the outlet opening is arranged between the first inlet opening and the second inlet opening; the apparatus further comprising at least one further filter arranged within the plenum, between the second inlet opening and the outlet opening.

In some embodiments, the at least one switchgear device is metal clad, and configured for indoor operation.

In a further aspect, the present invention resides in a method of filtering contaminated air expelled from a switchgear assembly following an arc fault, comprising: collecting the contaminated air expelled from the switchgear assembly in a collecting plenum; directing the contaminated air from the collecting plenum into a filtering plenum; passing the contaminated air through at least one filter to produce filtered air; and exhausting the filtered air from the filtering plenum.

The method may further comprise passing the contaminated air through a blast arrestor to reduce a flow rate of the contaminated air, before the contaminated air is passed through the at least one filter. A fan may be used to draw the contaminated air through the at least one filter, and to exhaust the filtered air from an outlet opening of the filtering plenum.

In some embodiments, the method further includes detecting the arc fault, and activating the fan when the arc fault is detected. This may be achieved by detecting smoke and/or light produced by the arc fault.

In at least some embodiments, the method further comprises preventing burning particles expelled from the switchgear assembly from entering the filtering plenum. The contaminated air may furthermore be cooled before it is passed through the at least one filter.

In some embodiments, the contaminated air is cooled to less than 120 degrees Celsius before it is passed through the at least one filter. In other embodiments, the contaminated air is cooled to less than 60 degrees Celsius before it is passed through the at least one filter. A shutter may be used to adjust the flow rate of the contaminated air.

Passing the contaminated air through the blast arrestor may comprise passing the contaminated air through a perforated metal sheet.

Passing the contaminated air through the at least one filter may comprise: removing smoke and toxic gas from the contaminated air; passing the contaminated air through at least one micro-glass filter; passing the contaminated air through at least one aluminum filter and at least one charcoal filter; removing all particles larger than 0.3 μm from the contaminated air;

and/or removing carbon monoxide from the contaminated air to a concentration of less than 10 ppm.

In some embodiments, at least one spark arrestor is used to prevent sparks from contacting the at least one filter.

The method may further comprise directing the contaminated air into two or more inlet openings of the filtering plenum.

Preferably, the apparatus and method prevent any arc by-products from being released from the switchgear assembly without first passing through the at least one filter.

### BRIEF DESCRIPTION OF THE DRAWINGS

Further aspects and advantages of the invention will appear from the following description taken together with the accompanying drawings, in which:

FIG. 1A shows a partially transparent perspective view of the front, top, and right sides of a switchgear assembly in accordance with a first preferred embodiment of the invention;

FIG. 1B shows a front view of the switchgear assembly shown in FIG. 1A;

FIG. 1C shows a side view of the switchgear assembly shown in FIG. 1A;

FIG. 1D shows a perspective view of a switchgear cell enclosure of the switchgear assembly shown in FIG. 1A;

FIG. 2 shows a partially transparent perspective view of the rear, top, and right sides of the switchgear assembly shown in FIG. 1A;

FIG. 3A shows a partially transparent perspective view of the rear, top, and left sides of a filtering plenum of the switchgear assembly shown in FIG. 1A;

FIG. 3B shows a schematic top view of the filtering plenum shown in FIG. 3A;

FIG. 3C shows a schematic rear view of the filtering plenum shown in FIG. 3A;

FIG. 3D shows a schematic sectional view taken along line A-A′ of the filtering plenum shown in FIG. 3C;

FIG. 4A shows a partially transparent perspective view of the rear, top, and left sides of a filtering plenum in accordance with a second preferred embodiment of the invention;

FIG. 4B shows a schematic rear view of the filtering plenum shown in FIG. 4A;

FIG. 4C shows a schematic top view of the filtering plenum shown in FIG. 4A;

FIG. 4D shows a schematic sectional view taken along line B-B′ of the filtering plenum shown in FIG. 4B;

FIG. 5A shows a partially transparent perspective view of the front, top, and right sides of a switchgear assembly in accordance with a third preferred embodiment of the invention;

FIG. 5B shows a perspective view of a switchgear cell of the switchgear assembly shown in FIG. 5A;

FIG. 5C shows a front view of the switchgear assembly shown in FIG. 5A;

FIG. 5D shows a perspective view of a collecting plenum of the switchgear assembly shown in FIG. 5A;

FIG. 5E shows a schematic sectional view taken along line C-C′ of the switchgear assembly shown in FIG. 5C; and

FIG. 5F shows an enlarged view of area X of the switchgear assembly shown in FIG. 5E.

The dimensions shown in the Figures are in inches.

### DETAILED DESCRIPTION OF THE DRAWINGS

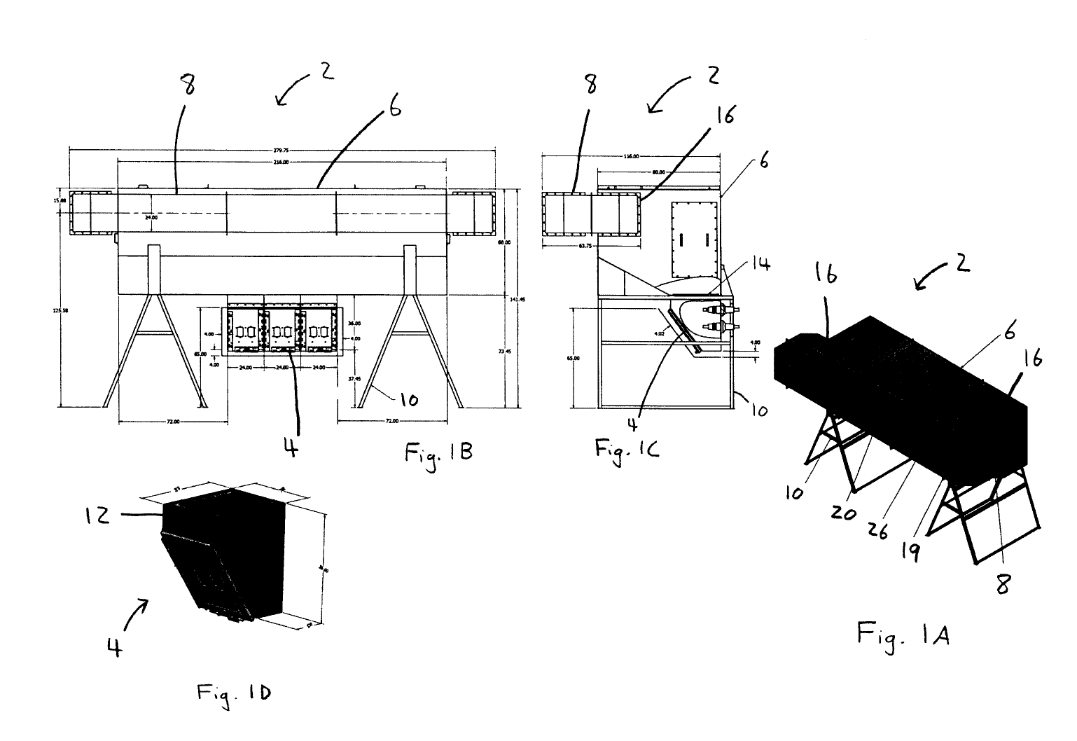

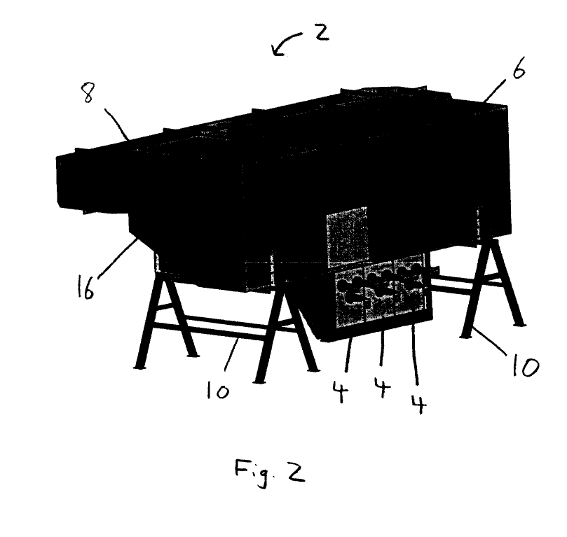

Reference is made first to FIGS. 1A, 1B, 1C and 2, which show a switchgear assembly 2 in accordance with a first preferred embodiment of the invention. The switchgear assembly 2 includes a set of arc-resistant metal clad switchgear cells 4, an arc by-product collecting plenum 6, and an arc by-product filtering plenum 8. The switchgear assembly 2 is mounted on supports 10.

The switchgear cells 4 are of a construction known to those skilled in the art, and incorporate standard electrical equipment, such as switching, interrupting and control devices, that are housed in an arc-resistant metallic enclosure 12. In the embodiment shown, the switchgear cells 4 are grounding cells, although it is to be appreciated that the present invention could be used with other types of switchgear devices as well. The enclosure 12 has a robust metallic construction designed to withstand the explosive forces of an arc fault, and to direct the arc by-products upwards, away from the front of the cells 4 where workers could be present, and into the arc by-product collecting plenum 6. The switchgear cells 4 may, for example, use an arc proof door assembly such as described in United States Patent Application Publication No. US 2013/0298468 to Gasparetto, published Nov. 14, 2013; or an arc-proof shield as described in U.S. Pat. No. 4,864,466 to Gasparetto, issued Sep. 5, 1989, both of which are hereby incorporated by reference. A double wall construction with a 3/16 inch air gap has been found to be effective in resisting burn through during an arc fault.

The collecting plenum 6 also has a robust metallic construction, to withstand the explosive forces created by an arc fault, and has a much larger internal volume than the switchgear cells 4. This large internal volume provides space for receiving the rapidly expanding gases produced by the arc fault, and thus ensures that the pressure within the collecting plenum 6 remains at a manageable level. The internal volume of the collecting plenum 6 is selected based on the arc conditions that could be produced by the associated switchgear cells 4. For example, cells 4 capable of producing a 50 kA arc fault will require a larger collecting plenum 6 than cells 4 capable of producing only a 25 kA arc fault. If the collecting plenum 6 is inadequately sized, the pressure spike caused by an arc fault could blast a hole in the plenum 6, allowing the toxic gas and smoke to escape. For example, the collecting plenum 6 should have a minimum volume of 300 cubic feet for a maximum arc magnitude of 63 kA RMS Sym.

The collecting plenum 6 has explosion flaps 14 associated with each switchgear cell 4, which are designed to swing open during an arc fault, to allow the arc by-products expelled from the associated switchgear cell 4 to enter the collecting plenum 6. The collecting plenum 6 also has exhaust ports 16, for releasing the contaminated air into the filtering plenum 8.

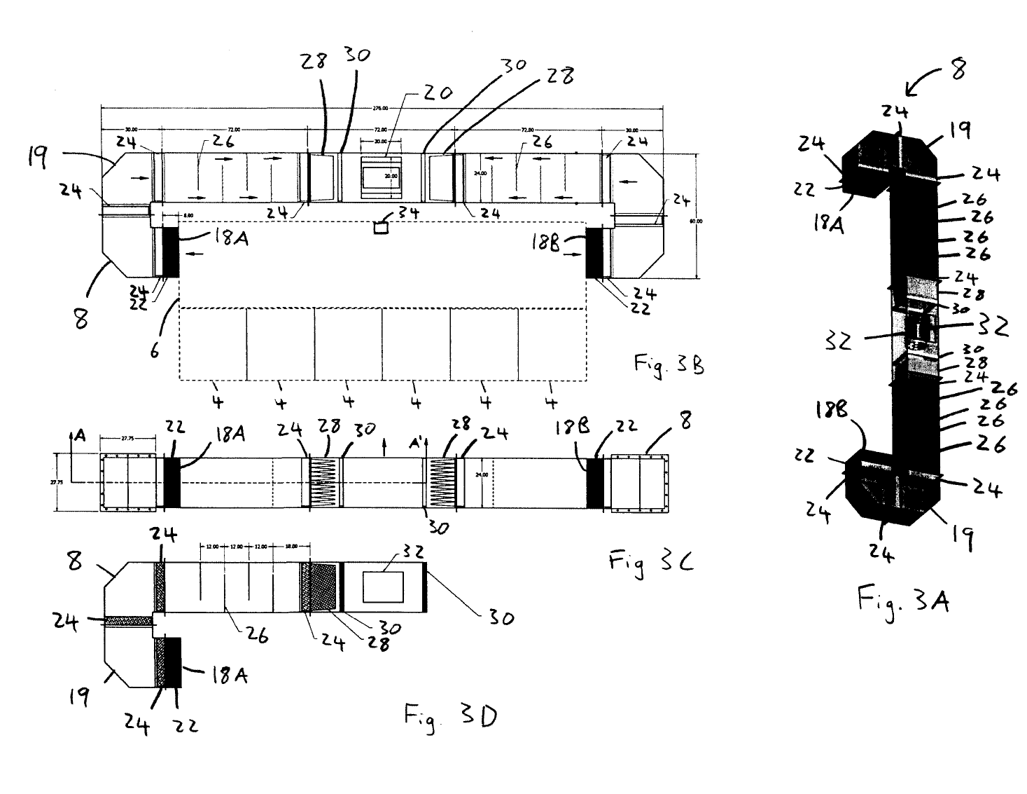

The filtering plenum 8 is best shown in FIGS. 3A, 3B, 3C and 3D as an elongated duct that extends from a first inlet opening 18A at one end, to a second inlet opening 18B at the other end. The first and second inlet openings 18A, 18B are arranged facing each other, with the collecting plenum 6 disposed therebetween. Elbow connections 19 connect the inlet openings 18A, 18B to an adjacent linear section of the plenum 8 having a centrally located outlet opening 20. The filtering plenum 8 is generally formed from sheet metal, though any suitable material capable of containing the contaminated air received from the collecting plenum 6 could be used.

Each inlet opening 18A, 18B engages with one of the exhaust ports 16 of the collecting plenum 6 in a fluid tight manner, such that all of the contaminated air exhausted from the collecting plenum 6 is received by the filtering plenum 8. For example, the inlet openings 18A, 18B could be bolted or welded to the exhaust ports 16 of the collecting plenum 6. Each inlet opening 18A, 18B is furthermore provided with a blast arrestor 22, which is configured to cool and reduce the flow rate of the contaminated air entering the filtering plenum 8. In the preferred embodiment which is shown, the blast arrestor 22 is a perforated metal sheet which is arranged to substantially obstruct the associated inlet opening 18A, 18B. By slowing the rate at which the contaminated air flows into the filtering plenum 8, the blast arrestor 22 permits the contaminated air to cool to a suitable temperature for filtration. For example, in some embodiments of the invention, the filtering plenum 8 may incorporate filters that require a temperature of 120 degrees Celsius or less, in order to effectively filter the contaminated air. The construction of the blast arrestor 22 is selected so that the contaminated air will be cooled to the required temperature when passing through the filtering plenum 8. The blast arrestor 22 furthermore prevents large burning particles from entering the filtering plenum 8, which protects the downstream components from being damaged thereby. In the embodiment which is shown, the perforations in the blast arrestor 22 have a diameter of 0.125 inches, and are spaced at 0.25 inches.

In the preferred embodiment which is depicted, three aluminum mesh filters 24 are arranged immediately downstream of each inlet opening 18A, 18B. The aluminum filters 24 are 4 inches wide and spaced from each other, and are provided to remove particles from the contaminated air. Preferably, each aluminum filter 24 is configured to remove particles that are smaller in size than those removed by the preceding upstream filters 24. For example, the first aluminum filter 24 following the blast arrestor 22 may remove particles having a diameter of 10 μm or greater; the next downstream aluminum filter 24 may remove smaller particles having a diameter of 5 μm or greater; and the following downstream aluminum filter 24 may remove even smaller particles having a diameter of 1 μm or greater. This gradual decrease in filtration size helps to ensure that the filters 24 that are designed to remove very small particles are not quickly clogged by much larger particles, and thus improves filtration performance. The aluminum filters 24 have a robust construction capable of withstanding the relatively high temperature conditions that may be experienced near the inlet openings 18A, 18B. The aluminum filters 24 may also act to further reduce the flow rate of the contaminated air, allowing the contaminated air to further cool before reaching the more temperature sensitive filters located downstream.

A set of spark arrestors 26 are arranged downstream of the aluminum filters 24. The spark arrestors 26 are configured to prevent sparks from passing therethrough, which helps to protect the downstream components from damage. The spark arrestors 26 may have any suitable construction known to a person skilled in the art, such as a metallic mesh or screen. A further aluminum filter 24 is provided after the spark arrestors 26.

The next downstream component is a high efficiency micro-glass bag filter 28, which is provided to remove smoke and very small particles from the contaminated air. For example, the micro-glass filter 28 may be capable of removing virtually all of the particles from the contaminated air that are 0.3 μm or larger. In the embodiment which is shown, the micro-glass filter 28 has a 4 square foot filtering surface.

A charcoal toxic gas filter 30 is provided downstream of the micro-glass filter 28, and is the final filter that the contaminated air passes through. The charcoal filter 30 is configured to absorb and remove toxic gases from the contaminated air, including CO, CH₄ and H₂S. The charcoal filter 30 is also effective at removing odours. The air which emerges from the charcoal filter 30 is fully filtered, with very low concentrations of particulate matter and toxic gases. The filtered air can be safely exhausted indoors or outdoors, without posing a risk to human health or to the environment.

An exhaust fan 32 is arranged within the filtering plenum 8 at the outlet opening 20, and is configured to draw the contaminated air through the filtering plenum 8, and to exhaust the filtered air through outlet opening 20. In the embodiment which is shown, the exhaust fan 32 is a centrifugal type fan, although it is to be appreciated that any suitable device capable of drawing the air through the filtering plenum 8 could be used. The exhaust fan 32 does not operate at a high capacity, as it is generally preferable for the contaminated air to move relatively slowly through the filtering plenum 8. This gives the air an opportunity to cool and depressurize, allowing for more effective filtration. In the embodiment which is shown, the electric fan 32 operates at 1 horsepower.

A detector 34 is placed within the collecting plenum 6 to detect the smoke, light, and/or heat produced by an arc fault. The detector 34 is operably linked to the exhaust fan 32, and is configured to activate the exhaust fan 32 when an arc fault is detected. In other embodiments of the invention, the exhaust fan 32 could instead be manually activated, or configured to operate continuously.

The switchgear assembly 2 was tested to confirm its ability to withstand an arc fault, and to exhaust clean air. The test assembly 2 was designed to withstand the transient pressure and thermal effects of an internal arc fault developed by a three phase symmetrical short circuit rated 25 kA RMS sym. Cotton indicators were arranged around the switchgear cells 4 to record the thermal effects of the arc fault.

The assembly 2 successfully withstood the arc, and no cotton indicators were ignited or burned. The doors of the switchgear cells 4 remained closed and latched, and no holes were created by the arc blast. The filtering plenum 8 furthermore successfully filtered the arc by-products, exhausting clean air into the room. No traces of smoke were detected, and gas detectors showed that only 8 ppm of CO was exhausted. No CH₄ or H₂S was detected in the exhausted air (0 ppm). The air was furthermore found to be over 99% clean, containing only particles smaller than 0.3 μm in diameter.

In addition to providing clean air which can be safely exhausted indoors or outdoors, the switchgear assembly 2 of the present invention also exhausts air at a greatly reduced pressure and temperature. This reduces the risks to nearby personnel and equipment.

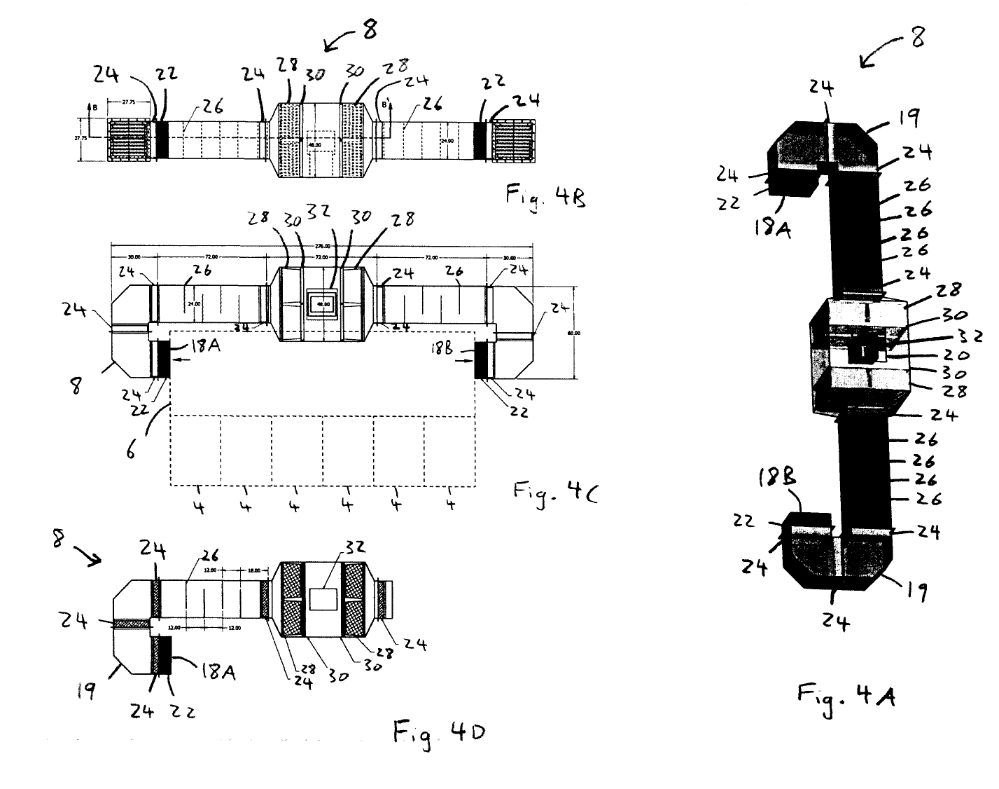

An alternative construction of the filtering plenum 8 in accordance with a second preferred embodiment of the invention is shown in FIGS. 4A, 4B, 4C and 4D, wherein like numerals are used to identify like components. The construction depicted in FIGS. 4A, 4B, 4C and 4D is generally identical to that shown in FIGS. 3A, 3B, 3C and 3D, with the exception that the filtering plenum 8 has an expanded section in the vicinity of the outlet opening 20, to accommodate larger micro-glass filters 28 and charcoal filters 30. The larger size of the filters 28, 30 permits the filtering plenum 8 to more effectively filter a greater volume of contaminated air. The volume of contaminated air produced by an arc fault can increase dramatically as the magnitude of the arc increases. Larger filters 28, 30 may be required to adequately filter the contaminated air produced by such faults. For example, the filtering plenum 8 shown in FIGS. 4A, 4B, 4C and 4D is adapted for use with switchgear cells 4 capable of producing a 50 kA arc, and for this reason incorporate larger filters 28, 30 having a 16 square foot filter surface.

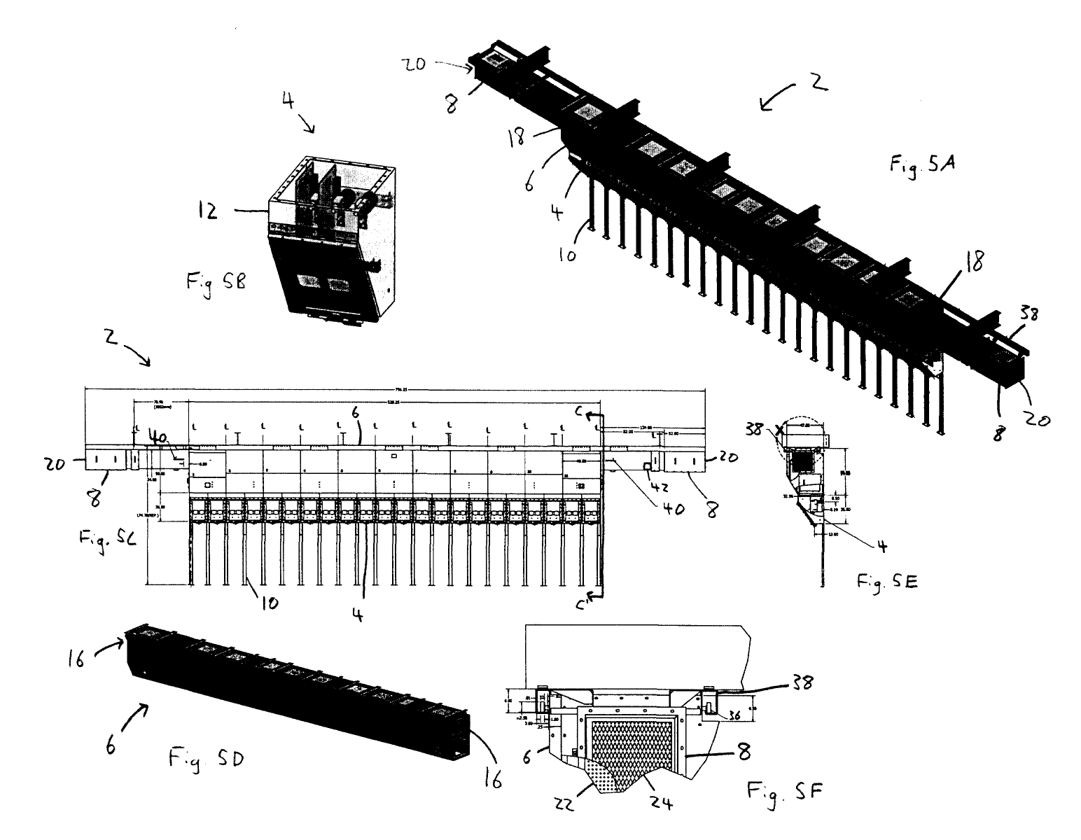

Reference may now be made to FIGS. 5A, 5B, 5C, 5D, 5E and 5F, which depict a switchgear assembly 2 in accordance with a third preferred embodiment of the invention, wherein like reference numerals are used to denote like components. As in the embodiments described above, the switchgear assembly 2 includes a set of switchgear cells 4, and a collecting plenum 6 for receiving the arc by-products produced by an arc fault. However, unlike in the previous embodiments, each exhaust port 16 of the collecting plenum 6 is associated with a separate filtering plenum 8. The use of separate filtering plenums 8 is particularly well suited for assemblies 2 having large collecting plenums 6, with exhaust ports 16 that are separated by a considerable distance. This arrangement furthermore permits the assembly 2 to have a modular design, wherein components may be added or removed as required.

In particular, the collecting plenum 6 and the filtering plenum 8 are each mounted on wheels 36 that sit within wheel channels 38. In the event that the assembly 2 requires modification, such as the addition of further switchgear cells 4, this arrangement permits the filtering plenum 8 to be easily moved aside. With the filtering plenum 8 moved out of the way, the collecting plenum 6 can be expanded to accommodate the additional switchgear cells 4, by adding a further section of plenum to the existing collecting plenum 6. The filtering plenum 8 can then be moved back into place, to engage with the exhaust port 16 of the newly expanded collecting plenum 6.

The filtering plenum 8 functions in much the same way as in the previously described embodiments. Although not all of the components are visible in the drawings, the filtering plenum 8 incorporates an inlet opening 18, an outlet opening 20, a blast arrestor 22, an aluminum filter 24, spark arrestors 26, a micro-glass filter 28, a charcoal filter 30, and an exhaust fan 32. The blast arrestors 22 reduces the flow rate of contaminated air entering the filtering plenum 8, as in the previously described embodiments. In addition, the filtering plenum 8 incorporates a shutter 40, which is rotatable to partially obstruct a flow path through the plenum 8. By adjusting the position of the shutter 40, the flow rate of the contaminated air passing through the filtering plenum 8 can be altered. For example, if the temperature of the contaminated air within the plenum 8 is too high for one or more of the filters 28, 30, the shutter 40 can be rotated to partially obstruct the flow path, thereby reducing the flow rate and giving the contaminated air further time to cool. In some embodiments of the invention, a temperature sensor 42 may be mounted within the filtering plenum 8, and configured to automatically adjust the position of the shutter 40 based on the detected temperature. In other embodiments, the shutter 40 may be adjusted manually.

As in the previously described embodiments, the filtering plenum 8 is configured to exhaust clean, filtered air that can be safely released indoors or outside. In a preferred embodiment, the filtering plenum 8 is rated to efficiently clean 35,000 cubic feet of air per minute.

The invention is not limited to the preferred embodiments described herein. A person skilled in the art will appreciate that there are many possible variations and modifications that fall within the scope of the invention.

For instance, the precise configurations and dimensions of the exemplary embodiments are not necessary for practicing the invention. Rather, any alternative construction that suitably collects the contaminated air produced by an arc fault, and directs the contaminated air through at least one filter to produce filtered air, could be used.

While the blast arrestor 22 has been shown in the exemplary embodiments as being located at the inlet opening 18 of the filtering plenum 8, this precise arrangement is not necessary. For example, the blast arrestor 22 could be installed within the collecting plenum 6, near the exhaust port 16. It could also be installed within the filtering plenum 8, but spaced from the inlet opening 18. For example, the blast arrestor 22 could be spaced so as to accommodate an exhaust flap of the exhaust port 16 that swings into the filtering plenum 8 during an arc fault. In other embodiments, the collecting plenum 6 and filtering plenum 8 may be formed from a single unitary plenum body, with the blast arrestor 22 separating the two functionally distinct areas. Any location of the blast arrestor 22 that adequately reduces the flow rate of the expelled gases could be used.

The blast arrestor 22 need not have the construction that is described and shown. For example, the blast arrestor 22 could be formed from multiple perforated metal sheets that are spaced closely together, or with any other construction that is able to sufficiently slow the flow of arc gases entering the plenum 8. In some embodiments of the invention, the size and/or configuration of the collecting plenum 6 may sufficiently cool the contaminated air before it reaches the filtering plenum 8, such that no blast arrestor 22 is needed. Furthermore, in some embodiments, the filters 28, 30 within the filtering plenum 8 may have a sufficiently robust construction that cooling of the contaminated gases prior to filtration is unnecessary.

While the preferred embodiments have shown a specific set and arrangement of filters 24, 28, 30, it is to be appreciated that the precise set and arrangement shown is not necessary to practice the invention. Rather, any arrangement of one or more filters that is able to provide the desired degree of filtration could be used. Filters made from different materials than those described could also be used, as desired.

While the preferred embodiments have described the use of an exhaust fan 32 to draw contaminated air through the filtering plenum 8, this is not always necessary. For example, in some circumstances the existing pressure differential between the contaminated air within the collecting plenum 6 and the surrounding environment may be sufficient to draw the contaminated air through the filtering plenum 8. In some cases, an existing ventilation system of the facility where the switchgear assembly 2 is installed could produce a sufficient pressure differential.

It will be understood that, although various features of the invention have been described with respect to one or another of the embodiments of the invention, the various features and embodiments of the invention may be combined or used in conjunction with other features and embodiments of the invention as described and illustrated herein.

Although this disclosure has described and illustrated certain preferred embodiments of the invention, it is to be understood that the invention is not restricted to these particular embodiments. Rather, the invention includes all embodiments which are functional, mechanical or electrical equivalents of the specific embodiments and features that have been described and illustrated herein.

We claim:

1. An apparatus for collecting and filtering contaminated air expelled from a switchgear assembly following an arc fault, comprising:
a plenum extending from an inlet opening to an outlet opening, the inlet opening configured for sealing engagement with the switchgear assembly, so as to receive the contaminated air expelled thereby; and
at least one filter arranged within the plenum for filtering arc by-products from the contaminated air;
wherein the apparatus is configured to direct the contaminated air through the at least one filter to produce filtered air, and to exhaust the filtered air from the outlet opening.

2. The apparatus according to claim 1, further comprising a blast arrestor arranged upstream of the at least one filter and configured to reduce a flow rate of the contaminated air.

3. The apparatus according to claim 1, further comprising a fan configured to draw the contaminated air through the at least one filter, and to exhaust the filtered air from the outlet opening.

4. The apparatus according to claim 3, further comprising an arc detecting device that activates the fan upon detecting the arc fault.

5. The apparatus according to claim 2, wherein the blast arrestor comprises a perforated metal sheet.

6. The apparatus according to claim 5, wherein the perforated metal sheet is arranged at the inlet opening.

7. The apparatus according to claim 5, wherein the perforated metal sheet has perforations sized to reduce the flow rate of the contaminated air sufficiently to allow the contaminated air to cool to a suitable temperature for the at least one filter.

8. The apparatus according to claim 1, wherein the at least one filter comprises at least one micro-glass filter, at least one aluminum filter, and at least one charcoal filter.

9. The apparatus according to claim 1, wherein the inlet opening is a first inlet opening configured for sealing engagement with a first exhaust port of the switchgear assembly;
wherein the plenum has a second inlet opening configured for sealing engagement with a second exhaust port of the switchgear assembly; and
wherein the outlet opening is arranged between the first inlet opening and the second inlet opening;
the apparatus further comprising at least one further filter arranged within the plenum, between the second inlet opening and the outlet opening.

10. A switchgear assembly comprising:
at least one switchgear device;
a collecting plenum configured to receive arc by-products expelled from the at least one switchgear device during an arc fault; and
a filtering plenum configured to filter contaminated air exhausted from the collecting plenum;
wherein the filtering plenum extends from an inlet opening to an outlet opening, the inlet opening in sealing engagement with an exhaust port of the arc by-product collecting plenum, so as to receive the contaminated air exhausted therefrom; and
wherein the filtering plenum comprises at least one filter for filtering the arc by-products from the contaminated air.

11. The switchgear assembly according to claim 10, further comprising a blast arrestor arranged between the collecting plenum and the at least one filter, the blast arrestor configured to reduce a flow rate of the contaminated air.

12. The switchgear assembly according to claim 10, further comprising a fan configured to draw the contaminated air through the at least one filter to produce filtered air, and to exhaust the filtered air from the outlet opening.

13. The switchgear assembly according to claim 11, wherein the blast arrestor comprises a perforated metal sheet.

14. The switchgear assembly according to claim 10, wherein the at least one filter comprises at least one micro-glass filter, at least one aluminum filter, and at least one charcoal filter.

15. A method of filtering contaminated air expelled from a switchgear assembly following an arc fault, comprising:
collecting the contaminated air expelled from the switchgear assembly in a collecting plenum;
directing the contaminated air from the collecting plenum into a filtering plenum;
passing the contaminated air through at least one filter to produce filtered air; and
exhausting the filtered air from the filtering plenum.

16. The method according to claim 15, further comprising:
passing the contaminated air through a blast arrestor to reduce a flow rate of the contaminated air, before the contaminated air is passed through the at least one filter.

17. The method according to claim 15, further comprising:
using a fan to draw the contaminated air through the at least one filter, and to exhaust the filtered air from an outlet opening of the filtering plenum.

18. The method according to claim 17, further comprising:
detecting the arc fault; and
activating the fan when the arc fault is detected.

19. The method according to claim 16, wherein passing the contaminated air through the blast arrestor comprises passing the contaminated air through a perforated metal sheet.

20. The method according to claim 15, wherein passing the contaminated air through the at least one filter comprises passing the contaminated air through at least one micro-glass filter, at least one aluminum filter, and at least one charcoal filter.
